(19) United States
(12) Patent Application Publication
(10) Pub. No.: US 2014/0076114 A1
(43) Pub. Date: Mar. 20, 2014

(54) CABLE STRIPPER HANDLE ASSEMBLY

(71) Applicant: Changzhou Amphenol Fuyang Communication Equip. Co., Ltd., Changzhou (CN)

(72) Inventors: Pengjin Wang, Changzhou (CN); Tingxing SHENG, Changzhou (CN)

(73) Assignee: Changzhou Amphenol Fuyang Communication Equip. Co., Ltd., Changzhou (CN)

(21) Appl. No.: 13/899,081

(22) Filed: May 21, 2013

(30) Foreign Application Priority Data
Sep. 17, 2012 (CN) 201220472125.0

(51) Int. Cl. B25G 1/10; H02G 1/12

(52) U.S. Cl. CPC B25G 1/102; H02G 1/1221
USPC 81/489

(57) ABSTRACT

A cable stripper handle assembly including a handle, a handle sleeve coupled to the handle and having a first portion and a second portion, a handle sleeve connector surrounding the second portion of the handle sleeve, the handle sleeve connector having first and second holes, the second hole having two opposing ends and intersecting the first hole, a unidirectional bearing received in the first portion of the handle sleeve, at least one marble positioned inside the second hole adjacent to at least one of the opposing ends thereof, and at least one spring positioned inside the second hole and contacting the at least one marble.

### RELATED APPLICATIONS

The present application claims priority under 35 U.S.C. § 119 to Chinese Patent Application No. 201220472125.0, filed Sep. 17, 2012, the entire disclosure of which is incorporated herein by reference.

### FIELD OF THE INVENTION

The present application relates to a stripper handle assembly for stripping cable. Specifically, the stripper handle assembly is a unidirectional rotary handle assembly that is used in connection with a cable stripper for a variety of types of cables, including power cables, communication cables, and the like.

### BACKGROUND OF THE INVENTION

Conventional cable stripping tools typically have handles and are usually assembled with screws. A screw driver or a spanner is necessary to assemble and disassemble the stripping tool, which is inconvenient for the operator. Further, in order to strip a cable, the operator must hold the conventional stripping tool with one hand and place the cable into the stripping tool with the other. The operator must then rotate the stripping tool with one hand while grasping the cable with the other. When the stripping tool is rotated to a certain angle, the operator must readjust his or her grip so as to be able to continuing rotating the tool in the same direction. As a result, the conventional stripping tool often falls down when the operator loosens his or her hold on the tool to rotate the same, thereby lowering the efficiency in using the stripping tool and causing inconvenience for the operator.

Accordingly, there is a need for a handle assembly for a cable stripper that improves cable stripping efficiency and is more convenient to operate.

### SUMMARY OF THE INVENTION

Accordingly, an exemplary embodiment of the present invention provides a cable stripper handle assembly that includes a handle, a handle sleeve that is coupled to the handle and that has a first portion and a second portion, a handle sleeve connector that surrounds the second portion of the handle sleeve and that has first and second holes, where the second hole has two opposing ends and intersects the first hole, a unidirectional bearing that is received in the first portion of the handle sleeve, at least one marble that is positioned inside the second hole adjacent to at least one of the opposing ends thereof, and at least one spring that is positioned inside the second hole and contacting the at least one marble.

The present invention also provides a cable stripper handle assembly that includes a handle that has a central portion, a connection sleeve that is positioned below the central portion of the handle, a first fastener that is positioned within the central portion of the handle, a unidirectional bearing that surrounds the connection sleeve, a handle sleeve that has a first portion that surrounds the unidirectional bearing and a second portion, a second fastener that is positioned within the second portion of the handle sleeve and extends into the connection sleeve, a handle sleeve connector that surrounds the second portion of the handle sleeve and has a through hole that is axially aligned with the first and second fasteners and a threaded hole that transverses the through hole and has two opposing ends, at least one marble that is positioned inside the threaded hole adjacent to each of the opposing ends, and at least one spring that is positioned adjacent to the two opposing ends of the threaded hole and contacts the at least one marble.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

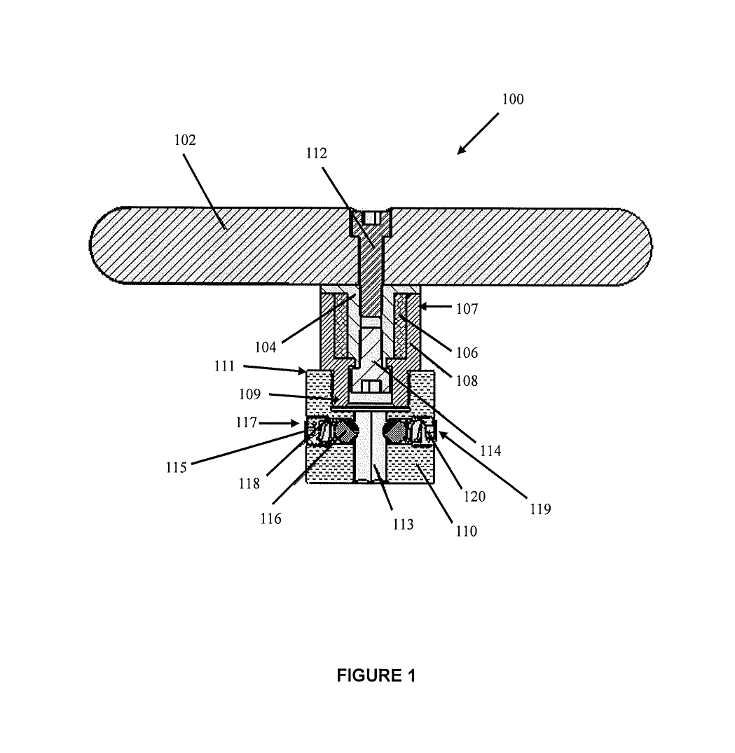

A more complete appreciation of the invention and many of the attendant advantages thereof will be readily obtained as the same becomes better understood by reference to the following detailed description when considered in connection with the accompanying drawing, FIG. 1, which is a cross-sectional view of a cable stripper handle assembly according to an exemplary embodiment of the present invention.

### DETAILED DESCRIPTION OF THE EXEMPLARY EMBODIMENTS

Referring to FIG. 1, the cable stripper handle assembly 100 according to an exemplary embodiment of the present invention generally includes a handle 102, a connection sleeve 104, a unidirectional bearing 106, a handle sleeve 108 and handle sleeve connector 110, first and second fasteners 112 and 114, respectively, a marble 116 and spring 118, and a choke plug screw 120. The handle assembly 100 allows for unidirectional rotation, which improves ease of use of the cable stripper, thereby improving its efficiency.

In a preferred embodiment, the handle 102 of the assembly 100 may have an elongated body, so as to provide adequate grip for the operator of the cable stripper (not shown). The handle assembly 100 may have a connection sleeve 104 positioned below the center of the handle 102. The connection sleeve 104 may be a substantially T-shaped structure having an interior bore to receive and connect other components of the assembly 100.

The connection sleeve 104 itself may be sleeved by a unidirectional bearing 106. The unidirectional bearing 106 allows the handle 102 to rotate in clockwise and counterclockwise directions. Because an operator has only one free hand to rotate a conventional cable stripper, once it has been rotated to a point that the operator can no longer twist his or her arm, he or she must release the handle and then re-grip the handle. The unidirectional bearing 106, however, allows the handle 102 to be rotated in one direction without engaging the cable stripper, and allows the cable stripper to operate (i.e., cut) when the handle 102 is rotated in the opposite direction (hence the term “unidirectional”). Specifically, the unidirectional bearing 106 has a locking mechanism that is engaged when the handle 102 is rotated in one direction, and disengaged when the handle 102 is rotated in the opposite direction. Thus, for example, clockwise rotation of the handle 102 will activate the locking mechanism that engages the cable stripper (allowing it to cut), and counterclockwise rotation of the handle will disengage the locking mechanism and allow the user to turn the handle 102 back to a starting position. This eliminates the need for the operator to re-grip the handle 102 when further rotation becomes impossible, thereby improving the efficiency of the cable stripper.

The handle sleeve 108 may have first and second portions 107 and 109, respectively, defined by two sides, such that the second portion 109 of the handle sleeve 108 is narrower than the first portion 107 (i.e., the sides of the second portion 109 are closer together). The unidirectional bearing 106 may then be sleeved by the first portion 107 of the handle sleeve 108.

A first fastener 112, such as a screw, may be positioned within the central part of the handle 102 such that the tail end of the first fastener 112 extends into the connection sleeve 104. A second fastener 114 may be positioned inside the second portion 109 of the handle sleeve 108 such that the tail of the second fastener 114 extends into the connection sleeve 104 spaced from the tail end of, and facing, the first fastener 112. The handle sleeve connector 110 may also be sleeved over the second portion 109 of the handle sleeve 108, abutting the ridge 111 where the handle sleeve 108 widens (i.e., the transition between the first portion 107 and the second portion 109). The center of the handle sleeve connector 110 may be provided with a first hole, such as through hole 113, that is axially aligned with the fasteners 112 and 114. The center of the handle sleeve connector 110 may also be provided with a second hole, such as threaded hole 115, that intersects the through hole 113. Preferably, the threaded hole 115 has two opposing ends, 117 and 119 respectively. At least one marble 116 may be positioned inside the threaded hole 115 on either side of the through hole 113 which divides the threaded hole 115. According to one embodiment, each marble 116 contacts a spring 118, which is positioned adjacent to the two opposing ends 117 and 119 of the threaded hole 115. A choke plug screw 120 may be positioned at each opposing end 117 and 119 of the horizontal threaded hole to engage each of the springs 118. In this way, the cable stripper can be removably attached to the handle assembly 100, as opposed to the conventional method of screwing the two components together. Specifically, a cable stripper (not shown) is designed with a projection having a marble slot on a surface thereof. This projection is inserted into through hole 113 inside the handle sleeve connector 110. The marbles 116 of the cable handle assembly 100 make contact with the marble slot on the surface of the cable stripper projection. The springs 118 exert force upon the marbles 116, and the marbles in turn exert force on the cable stripper projection, such that the cable stripper is held in place. To be sure, the force exerted by the marbles on the marble slot of the cable stripper projection must be greater than the force of gravity acting to pull the cable stripper projection out of the through hole 113. In this way, the cable stripper can be coupled to the handle assembly 100. It can then easily be removed simply by pulling on the handle 102 (or cable stripper) with enough force to disengage the marbles 116 from the marble slot on the cable stripper projection.

The handle assembly 100 according to the present invention may be assembled and disassembled easily and is capable of unidirectional rotation during operation. Essentially, the assembly 100 can be rotated counterclockwise or clockwise, while still stripping the cable, without the need for the operator to readjust or loosen his or her grip on the handle. Thus, slipping or falling of the cable stripper during operation is avoided. The marble/spring component allows the handle assembly 100 to be removably connected to the cable stripper, without the need to fix the components together with screws. As a result, the efficiency of the cable stripper is improved and the cable stripper is more convenient to use.

While particular embodiments have been chosen to illustrate the invention, it will be understood by those skilled in the art that various changes and modifications can be made therein without departing from the scope of the invention as defined in the appended claims.

What is claimed is:

1. A cable stripper handle assembly, comprising:
a handle;
a handle sleeve coupled to said handle and having a first portion and a second portion;
a handle sleeve connector surrounding said second portion of said handle sleeve, said handle sleeve connector having first and second holes, said second hole having two opposing ends and intersecting said first hole;
a unidirectional bearing received in said first portion of said handle sleeve;
at least one marble positioned inside said second hole adjacent to at least one of said opposing ends thereof; and
at least one spring positioned inside said second hole and contacting said at least one marble.

2. The cable stripper handle assembly according to claim 1, wherein
said first hole of said handle sleeve connector is a through hole; and
said second hole of said handle sleeve connector is a threaded hole.

3. The cable stripper handle assembly according to claim 2, further comprising:
at least one choke plug screw positioned within said at least one opposing end of said second hole, wherein said choke plug screw engages said at least one spring.

4. The cable stripper handle assembly according to claim 1, further comprising:
a connection sleeve positioned below a central portion of said handle; and
a first fastener having a tail end, said first fastener being positioned within said central portion of said handle and said tail end thereof extending into said connection sleeve.

5. The cable stripper handle assembly according to claim 4, wherein said first hole of said handle sleeve connector is axially aligned with said first fastener.

6. The cable stripper handle assembly according to claim 4, wherein said unidirectional bearing surrounds said connection sleeve.

7. The cable stripper handle assembly according to claim 4, further comprising a second fastener positioned within said second portion of said handle sleeve and extending into said connection sleeve.

8. The cable stripper handle assembly according to claim 1, further comprising another marble positioned inside said second hole adjacent to the other of said opposing ends thereof.

9. The cable stripper handle assembly according to claim 8, further comprising another spring positioned inside said second hole and contacting said another marble.

10. A cable stripper handle assembly, comprising:
a handle having a central portion;
a connection sleeve positioned below said central portion of said handle;
a first fastener positioned within said central portion of said handle;
a unidirectional bearing surrounding said connection sleeve;
a handle sleeve having a first portion and a second portion, said first portion surrounding said unidirectional bearing;
a second fastener positioned within said second portion of said handle sleeve and extending into said connection sleeve;
a handle sleeve connector surrounding said second portion of said handle sleeve, said handle sleeve connector having a through hole that is axially aligned with said first and second fasteners, and a threaded hole that transverses said through hole, said threaded hole having two opposing ends;
at least one marble positioned inside said threaded hole adjacent to each of said opposing ends; and
at least one spring being positioned adjacent to said two opposing ends of said threaded hole and contacting said at least one marble.

11. The cable stripper handle assembly of claim 10, wherein said first fastener has a tail end extending into said connection sleeve.

12. The cable stripper handle assembly of claim 10, further comprising at least one choke plug screw located at each of said opposing ends of said threaded hole, wherein said choke plug screw engages said at least one spring.
